(19) United States
(12) Patent Application Publication
(10) Pub. No.: US 2003/0168531 A1
(43) Pub. Date: Sep. 11, 2003

(54) Fuel injection valve and method for the production of valve needles or valve closing bodies for fuel injection valves

(76) Inventor: Martin Maier, Moelingen (DE)

Correspondence Address: KENYON & KENYON, ONE BROADWAY, NEW YORK, NY, 10004, US

(21) Appl. No.: 10/169,859

(22) PCT Filed: Nov. 9, 2001
(86) PCT No.: PCT/DE01/04189

(30) Foreign Application Priority Data
Nov. 9, 2000 (DE) 100 55 483.0

(51) Int. Cl. B05B 15/08

(52) U.S. Cl. 239/587.1

(57) ABSTRACT

A fuel injector (1) for fuel injection systems of internal combustion engines includes an actuator (10) and a valve needle (3) that is actuated by the actuator (10) for actuating the valve-closure member (4), which together with a valve-seat surface (6) forms a sealing seat, the valve needle (3) and/or the valve-closure member (4) having at least one swirl channel (35) that is introduced on a periphery. The at least one swirl channel (35), in this context, has a variable cross section along the flow direction of the fuel. The at least one swirl channel (35), when the fuel injector (1) is actuated, undergoes an axial shortening of its throttling length as a result of the motion of the valve needle (3) in a stroke direction.

### BACKGROUND INFORMATION

The present invention relates to a fuel injector according to the species of claim 1 and to a method for manufacturing valve needles of fuel injectors according to the species of claim 11.

From German Patent 38 08 635 C2, a fuel injector is known for directly injecting fuel into the combustion chamber of a mixture-compressing internal combustion engine, the fuel injector having a magnetically actuated valve needle having screw-shaped swirl grooves for generating a swirling flow of the injection jet, the overall cross-sectional surface of the swirl grooves being at least half the size of the cross-sectional surface of the outlet opening.

Additionally, a fuel injector is proposed in German Patent 31 21 572 A1 that functions in particular for fuel injection systems of internal combustion engines. The fuel injector includes a movable valve part, which cooperates with a valve seat that is provided in a nozzle body, a preparation bore being arranged downstream of the valve seat. Partially inserted into the preparation bore is a swirl insert, which has open swirl channels around its periphery. The swirl channels run in the axial direction from one end to the other of the swirl insert slanted with respect to the longitudinal axis of the fuel injector, and they discharge tangentially into the preparation bore. The swirl channels at the same time function as metering channels, whose throttling length can be changed by shifting the swirl insert in the preparation bore.

One disadvantage of the fuel injectors known from the aforementioned publications is, in particular, the high manufacturing cost of the swirl insert as a function of the high manufacturing precision. Due to nonuniformly shaped swirl grooves, inhomogeneities arise in the jet image thus resulting in flaws in the combustion, elevated exhaust emission values, and increased fuel consumption.

### ADVANTAGES OF THE INVENTION

In contrast, the fuel injector according to the present invention having the characterizing features of claim 1 and the method according to the present invention having the characterizing features of claim 10 have the advantage that, on the one hand, the swirl of the mixture cloud injected into the combustion chamber is prepared such that it can be adjusted to the operating condition of the fuel injector using appropriately shaped swirl channels, and that, on the other hand, the manufacture of the swirl-preparing components can be accomplished in a cost-effective and very flexible manner through the use of computer-controlled laser methods.

In addition, it is advantageous that the swirl channels are exclusively limited to the area surrounded by the guide disk, because in this manner it is possible to exert further influence on the throttling length of the swirl channels and therefore on the fuel flow.

As a result of the measures discussed in the subclaims, advantageous refinements and improvement of the fuel injector indicated in claim 1 and of the method indicated in claim 10 are possible.

Especially advantageous is the multiplicity of possible shapes for the swirl channels, making possible a very good spray preparation taking into account the operating state and the stoichiometry.

In this context, shapes are primarily advantageous that taper in the spray-discharge direction either in the radial direction or in the axial direction or in any combination of the two directions, it being possible as a result to accelerate the flow of fuel passing through the swirl channels.

Asymmetrical shapes of the swirl channels are also advantageous as a result of the more uniform overlapping of the individual fuel jets especially in partial-load operation of the fuel injector.

Drawing

Exemplary embodiments of the present invention are depicted in simplified form in the drawing and are discussed in greater detail in the description below. The following are the contents:

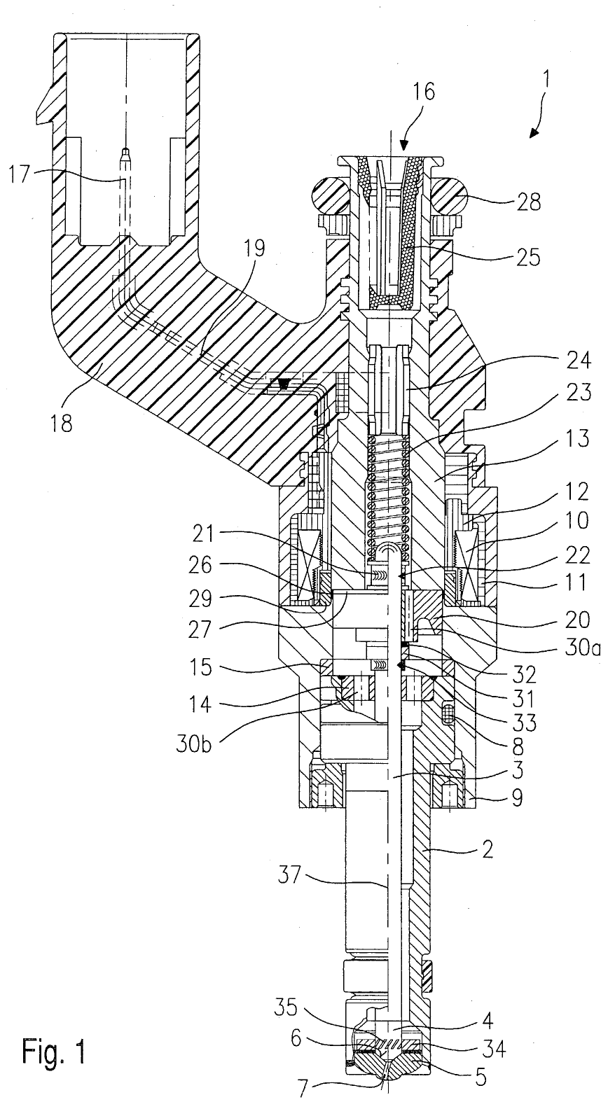

FIG. 1 depicts an axial section of a first exemplary embodiment of a fuel injector according to the present invention,

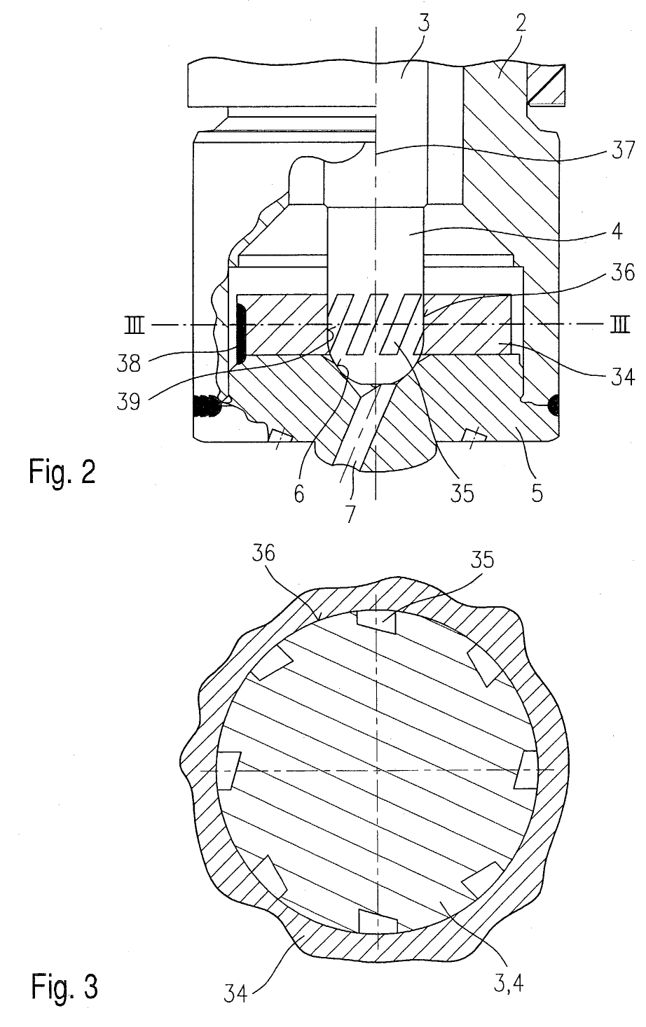

FIG. 2 depicts an enlarged section of the fuel injector according to the present invention in area II in FIG. 1,

FIG. 3 depicts a schematic section along the line III-III in FIG. 2, and

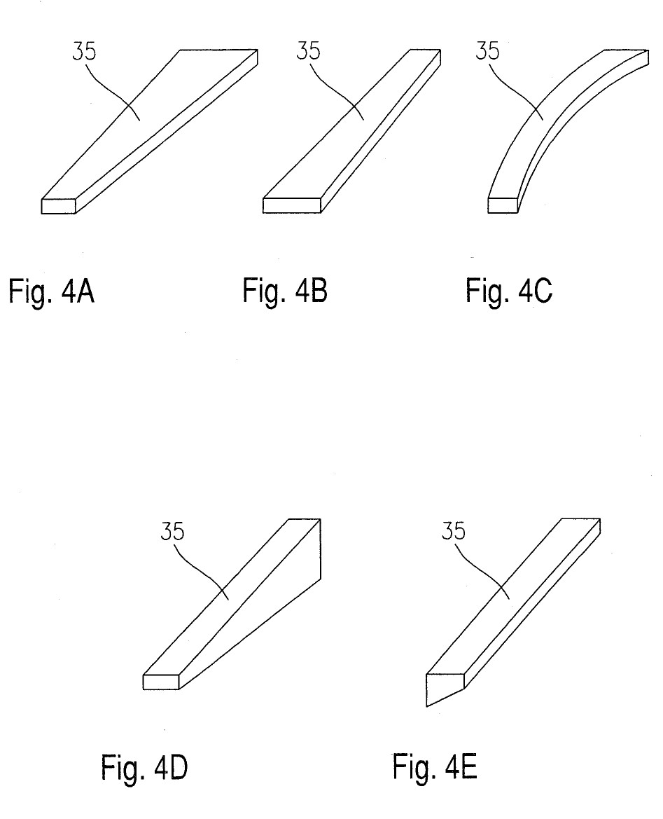

FIGS. 4A-4E depict exemplary embodiments of swirl channels that are produced using the method according to the present invention.

### DESCRIPTION OF THE EXEMPLARY EMBODIMENTS

Before the exemplary embodiments of a fuel injector 1 according to the present invention, having a valve needle 3 that is manufactured according to the present invention, are described in greater detail on the basis of FIGS. 2 through 4, fuel injector 1 according to the present invention is briefly described in an overall presentation with reference to its essential components in order to improve the understanding of the present invention.

Fuel injector 1 is executed in the form of a fuel injector for fuel injection systems of mixture-compressing, spark-ignition internal combustion engines. Fuel injector 1 is especially well-suited for the direct injection of fuel into an undepicted combustion chamber of an internal combustion engine.

Fuel injector 1 includes a nozzle body 2, in which valve needle 3 is arranged. Valve needle 3 is in operative connection with a valve-closure member 4, which cooperates with a valve-seat surface 6 arranged on a valve seat body 5 to form a sealing seat. In the exemplary embodiment, fuel injector 1 is an inward-opening fuel injector 1, which has available at least one spray-discharge opening 7. Nozzle body 2 is sealed by a gasket seal 8 against external pole 9 of a solenoid coil 10. Solenoid coil 10 is encapsulated in a coil housing 11 and is wound on a coil support 12, which contacts an interior pole 13 of solenoid coil 10. Interior pole 13 and exterior pole 9 are separated from each other by a gap 26 and are supported on a connecting component 29. Solenoid coil 10 is excited via a line 19 by an electrical current that is supplied via an electrical plug-in contact 17. Plug-in contact 17 is surrounded by a plastic sleeve 18, which can be injection-molded on interior pole 13.

Valve needle 3 is guided in a valve-needle guide piece 14, which is executed in a disk shape. To adjust the stroke, there is a paired adjusting disk 15. Located on the other side of adjusting disk 15 is an armature 20. The latter is connected in a force-locking manner via a first flange 21 to valve needle 3, which is joined by a welded seal 22 to first flange 21. Supported on first flange 21 is a resetting spring 23, which in the present design of fuel injector 1 is biased by a sleeve 24.

A second flange 31, which is connected to valve needle 3 via a welded seal 33, acts as a lower armature stop. An elastic intermediate ring 32, which contacts second flange 31, prevents rebounding when fuel injector 1 is closed.

Configured on the supply side of the sealing seat is a guide disk 34, which assures a central orientation of valve needle 3 and therefore counteracts a tilting of valve needle 3 and resulting imprecisions in the quantity of fuel metered. In the area of guide disk 34, valve needle 3, or in the present exemplary embodiment valve-closure member 4 which is configured as one piece along with valve needle 3, has swirl channels 35, which are introduced on an exterior periphery 36 of valve needle 3, or valve-closure member 4, using the manufacturing method according to the present invention that is described in greater detail below. A more precise depiction of swirl channels 35 can be obtained from FIGS. 2 through 4.

Running in valve needle guide piece 14 and in armature 20 are fuel channels 30a and 30b. The fuel is conveyed via a central fuel supply 16 that is filtered by a filter element 25. Fuel injector 1 is sealed against an undepicted fuel supply line by a gasket seal 28.

In the resting state of fuel injector 1, armature 20 is acted upon by resetting spring 23 in opposition to its stroke direction, so that valve-closure member 4 is held in a sealing position on valve seat 6. When solenoid coiled 10 is excited, the latter creates a magnetic field, which moves armature 20 in the stroke direction in opposition to the spring force of resetting spring 23, the stroke being determined by a working gap 27 located, in the resting position, between interior pole 12 and armature 20. Armature 20 also takes with it in the stroke direction flange 21, which is welded to valve needle 3. Valve-closure member 4, which is in an operative connection to valve needle 3, lifts off from valve-seat surface 6, and the fuel is spray-discharged.

If the coil current is switched off, armature 20, after a sufficient decay of the magnetic field, falls away from interior pole 13 as a result of the pressure of resetting spring 23, flange 21 that is in an operative connection with valve needle 3 moving in opposition to the stroke direction. Valve needle 3 as a result is moved in the same direction, valve-closure member 4 therefore being placed on valve-seat surface 6, and fuel injector 1 being closed.

FIG. 2 in a partial, schematic, axial, sectional view depicts the outlet-side end of fuel injector 1 configured in accordance with the present invention in area II in FIG. 1. The elements already described in all Figures are provided with corresponding reference numerals.

As already mentioned with regard to FIG. 1, valve needle 3, or valve-closure member 4 which in the preferred exemplary embodiment is configured as one piece along with valve needle 3, has a plurality of circumferentially arranged swirl channels 35. Swirl channels 35, in this context, extend on periphery 36 of valve-closure member 4 essentially in the area of guide disk 34 diagonally with respect to a longitudinal axis 37 of fuel injector 1. As a result, swirl channels 35 are closed off radially and to the outside apart from an intake/outflow segment.

The guide disk is fixedly joined to valve seat body 5 by a welded seal 38 and in this manner stabilizes valve needle 3 so that centering offsets and resulting malfunctions of fuel injector 1 are counteracted.

As a result of the specific arrangement of swirl channels 35, it is possible, in connection with the shape of the swirl channels, to shape the mixture cloud that is injected into the combustion chamber of the internal combustion engine in any way desired. Because swirl channels 35 terminate flush against guide disk 34, the flow path of the fuel through swirl channels 35, or the throttling length of swirl channels 35 along valve-closure member 4 in the area of guide disk 34, is maximum in the closed state of fuel injector 1. If fuel injector 1 is opened as a result of the actuation of actuator 10, valve-closure member 4 lifts off from valve-seat surface 6. As a result, swirl channels 35 relative to guide disk 34 are shifted in the stroke direction of valve needle 3. As a result, the flow path of the fuel flowing through fuel injector 1 through swirl channels 35 is shifted axially, thus making it possible, assuming an appropriate configuration of swirl channels 35, to exert influence on the jet image of the spray-discharged fuel. Corresponding shapes of swirl channels 35 are depicted in FIGS. 4A through 4E.

FIG. 3 in a partial cutaway depiction shows a section of guide disk 34 and valve-closure member 4 along the line designated in FIG. 2 as III-III.

In the exemplary embodiment described here, eight swirl channels 35 are provided at regular angular distances on periphery 36 of valve-closure member 4. As the cross-sectional shape, an asymmetrical-cross section was selected as representative for a multiplicity of other possible shapes. However, the cross section can also be uniformly rectangular, semicircular, or triangular, and even sectioned bevels are conceivable.

In this context, the number of swirl channels 35 can be freely chosen, as well as their slant relative to longitudinal axis 37 of fuel injector 1. Thus, for example, it is also conceivable to have a single swirl channel 35, which extends in a spiral shape over entire periphery 36 of valve-closure member 4. Preferably, the number, shape, and depth of swirl channels 35 are designed so that no undesirable throttle effects can arise.

FIGS. 4A through 4E depict exemplary embodiments for preferred cross-sectional shapes of swirl channels 35 configured on valve-closure member 4.

In this context, swirl channels 35 are introduced on valve needle 3 and/or on valve-closure member 4 using computer-assisted laser machining. The particular advantage of laser machining, in this context, lies in its high flexibility. If fuel injectors 1 having different swirl disks are to be produced using conventional swirl production methods, then for every new swirl-disk shape a separate stamping or injection mold must be made. However, as a result of the fixed shape of the swirl disk, the necessity is still ignored of achieving a swirl preparation as a function of the operating condition by exerting an appropriate influence on the jet image. In contrast, for generating new shapes of swirl channels 35, laser machining requires only minor changes in the control software of the laser.

The method according to the present invention of laser machining, in connection with the exemplary cross-sectional shapes described below, assures a simple, precise, and technically advantageous manufacture of swirl channels 35, which in addition have the advantage of influencing the jet image in accordance with the operating condition.

FIG. 4A depicts a swirl channel 35, which in the downstream direction has a tapering cross section. In this context, the basic shape is rectangular. A similar effect of a narrowing in the cross section can also be achieved, for example, by a square shape.

The advantage of this shape of swirl channels 35 lies in the acceleration of the fuel achieved, in accordance with the continuity equation, by the narrowing of the cross section that is traversed by the flow. Swirl channels 35 therefore act as a convector.

FIG. 4B depicts a swirl channel 35, which expands in the downstream direction. The advantage of this shape lies especially in homogenizing the injected jet, because the individual jets of the fuel flowing through swirl channels 35 overlap each other, and therefore a closed injection cone is produced.

FIG. 4C depicts a bent swirl channel 35. This has a constant cross section, but is bent in a radius of curvature that can be freely selected. As a result of the bending, the direction of the individual fuel jets can be shaped in any way, thus making it possible to adjust the injected mixture cloud to the geometry of the combustion chamber.

FIG. 4D depicts a swirl chamber 35, whose radial depth is variable over the length of swirl channel 35 and decreases in the downstream direction. This cross-sectional shape is similar to that depicted in FIG. 4A and also acts as a convector.

In this context, although not depicted here, the depth can also increase in the downstream direction, which is especially advantageous for partial-mode operation, because the mixture cloud changes from a hollow cone to an at least partially filled injection cone having a fat core, which can be produced by individual jets that overlap radially to the inside.

FIG. 4E represents the asymmetrical cross-sectional shape described already in FIG. 3. In this shape, the depth of swirl channels 35 varies in a circumferential direction of valve needle 3, or of valve-closure member 4.

The particular advantage of this cross-sectional shape lies in the homogenization of the mixture cloud, because it is possible to configure the fuel jets in a wedge shape and therefore to maintain the overlapping area of the individual jets in a stoichiometric manner, because in an asymmetrical jet shape, the mixture in the overlapping area tends to become fat.

In addition to the cross-sectional shapes described, a multiplicity of other shapes is also conceivable. In particular, it is advantageous to combine different shapes, in order to combine the advantages of the individual cross-sectional shapes. Thus, for example, a combination of the shapes in FIGS. 4A and 4C or the shapes from 4A and 4D is advantageous.

The present invention is not limited to the exemplary embodiments depicted and is applicable, in particular, to fuel injectors 1 having piezoelectrical or magnetostrictive actuators 10, to all shapes of swirl channels 35, and to all design variants of fuel injectors 1.

What is claimed is:

1. A fuel injector (1) for fuel injection systems of internal combustion engines, having an actuator (10) and a valve needle (3) that is actuated by the actuator (10) for actuating a valve-closure member (4), which along with a valve-seat surface (6) forms a sealing seat, the valve needle (3) and/or the valve-closure member (4) having at least one circumferentially arranged swirl channel (35), which has a variable cross section and/or a variable shape along the flow direction of the fuel,
wherein the at least one swirl channel (35), when the fuel injector (1) is actuated, undergoes an axial shortening of throttling length as a result of a motion of the valve needle (3) in a stroke direction.

2. The fuel injector as recited in claim 1,
wherein the at least one swirl channel (35) is configured on a periphery (36) of the valve needle (3) and/or of the valve-closure member (4).

3. The fuel injector as recited in claim 1 or 2,
wherein the at least one swirl chamber (35) is closed off radially to the outside by a guide disk (34).

4. The fuel injector as recited in claim 3,
wherein the at least one swirl channel (35) is limited to the area of the guide disk (34).

5. The fuel injector as recited in one of claims 1 through 4,
wherein a cross section of the at least one swirl channel (35) narrows in the downstream direction.

6. The fuel injector as recited in one of claims 1 through 4,
wherein a cross section of the at least one swirl channel (35) enlarges in the downstream direction.

7. The fuel injector as recited in one of claims 1 through 4,
wherein the at least one swirl channel (35) has a bend in the axial direction.

8. The fuel injector as recited in one of claims 1 through 7,
wherein a radial depth of the at least one swirl channel (35) decreases in the downstream direction.

9. The fuel injector as recited one of claims 1 through 4,
wherein the at least one swirl channel (35) has an asymmetrical cross section.

10. A method for manufacturing a valve needle (3) and/or a valve-closure member (4) for a fuel injector (1) for fuel injection systems of internal combustion engines, including an actuator (10) and a valve needle (3) that is actuated by the actuator (10) for actuating the valve-closure member (4), which together with a valve-seat surface (6) forms a sealing seat, the valve needle (3) and/or the valve-closure member (4) having at least one swirl channel (35) that is introduced on a periphery (36), the swirl channel having a radial cross section that is variable in the axial direction and, along the flow direction of the fuel, having a variable cross section and/or a variable shape, the at least one swirl channel (35), upon the actuation of the fuel injector (1), undergoing an axial shortening of its throttling length as a result of the motion of the valve needle (3) in a stroke direction,
wherein the at least one swirl channel (35) is introduced using computer-assisted laser machining in the exterior periphery (36) of the valve needle (3) and/or of the valve-closure member (4).
